(19) United States
(12) Patent Application Publication
(10) Pub. No.: US 2011/0250391 A1
(43) Pub. Date: Oct. 13, 2011

(54) Needlepoint system

(76) Inventor: Wendy Dorchester, Corona Del Mar, CA (US)

(21) Appl. No.: 12/798,697

(22) Filed: Apr. 12, 2010

(51) Int. Cl. B32B 3/10; B32B 37/12; B32B 38/14

(52) U.S. Cl. 428/138; 156/277; 156/280

(57) ABSTRACT

A process for fabricating needlepoint canvas wherein a blank mesh and a blank interface sheet are first merged using heat. Then a pattern is printed onto the combined mesh and interface composite using a variety of techniques including silk screening and printing with an inkjet style computer controlled printer f. The resulting canvas mesh composite can be sold in standard picture frame sizes to facilitate subsequent framing after completion of the needlepoint job.

### BACKGROUND OF THE INVENTION

1. Field of the Invention

The present invention relates generally to needlepoint craft of the type wherein yarn is stitched into a mesh canvas having a printed pattern to form a fabric-based object or art form. The invention herein relates more specifically to a needlepoint system having certain improvements to make the mesh canvas more portable, to make the mesh less likely to fray or unravel, to make the design pattern more visible and to produce a readily frameable art form upon completion of the needlepoint project.

2. Background Art

Needlepoint is a craft that uses yarn stitched into a mesh canvas according to a pre-printed pattern or design on the mesh canvas surface. The needlepoint process typically consists of making diagonal stitches across each of the intersections in the mesh canvas using differently colored yarn dictated by the pre-printed pattern or design. The completed canvas can then be made into artistically adorned objects such as show pillows, floor coverings, wall hangings, dolls and other fabric-based objects.

Unfortunately, needlepoint has lost popularity because it can be expensive, time consuming and difficult. Hand painted mesh canvases can cost as much as $100 to $200 per design and yarn and may require many months or even years to complete. In addition to the cost and time required, the mesh canvas can fray and unravel becoming difficult to handle. The designs which are painted onto the mesh can be difficult to see because much of the mesh consists of open rectangles. The needlepoint canvas is often placed in a cumbersome wooden stretcher system to make it easier to stitch but making it less portable. Cotton canvas mesh distorts as it is stitched requiring the canvas to be blocked back into shape before the needlepoint process can continue. The finished canvas typically has to be professionally shaped into a three-dimensional object such as a pillow or doll and this adds to the overall cost.

### SUMMARY OF THE INVENTION

The present invention overcomes the aforementioned problems of prior art needlepoint materials. The preferred embodiments of the invention described herein provide a mesh canvas that won't fray or unravel; provide a much more discernable imprinted design pattern that obviates use of a stretcher; and that permits the resulting fabric artwork to be displayed in standard size picture frames at virtually no cost beyond the cost of the frame itself.

These novel improvements are achieved by:

1. Interface backing—Needlepoint canvas is backed (laminated) with fusible interfacing non-woven fabric. By laminating the heat fusible interface fabric to the back of the needlepoint canvas, the thickened canvas will not distort when stitched, will not fray and does not require a stretcher system. Because it does not require stretchers it is very portable.

2. Design printed on both the canvas mesh AND the interface backing—In order to make stitching the design easier, the design is printed (using screen printing techniques or a computer color printer) on both the mesh AND the interface backing, not just the mesh. This makes the design much clearer, crisper and the colors easier to distinguish. The actual stitching is done through both the mesh AND the interface. Because the stitching is done over the design colored canvas mesh and the interfacing, the yarn fills in the design more completely (no white mesh showing).

3. “Photo-sized” needlepoint—The needlepoint canvas is stiffened by the interfacing and stitching and will not fray. If the designs are standard photo size (3.5″×5″, 4″×6″, 5″×7″ etc.), the finished canvas may be easily trimmed to be suitable for framing, displaying in a scrapbook or any other photo display. Also, the designs are smaller than a traditional pillow and much less time consuming to complete.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a three-dimensional illustration of the two layers which make up the laminate of the needlepoint canvas of the preferred embodiment;

FIG. 2 is a cross-sectional view of the canvas of FIG. 1;

FIG. 3 is a top view of a printing step in the process of the invention using a standard computer-connected color printer;

FIG. 4 is a view of a printed needlepoint laminate canvas of a preferred embodiment;

FIG. 5 is a cross-sectional view of the printed canvas of FIG. 4; and

FIG. 6 is a plan view of a framed needlepoint artwork of a stitched canvas of the invention.

### DETAILED DESCRIPTION OF A PREFERRED EMBODIMENT

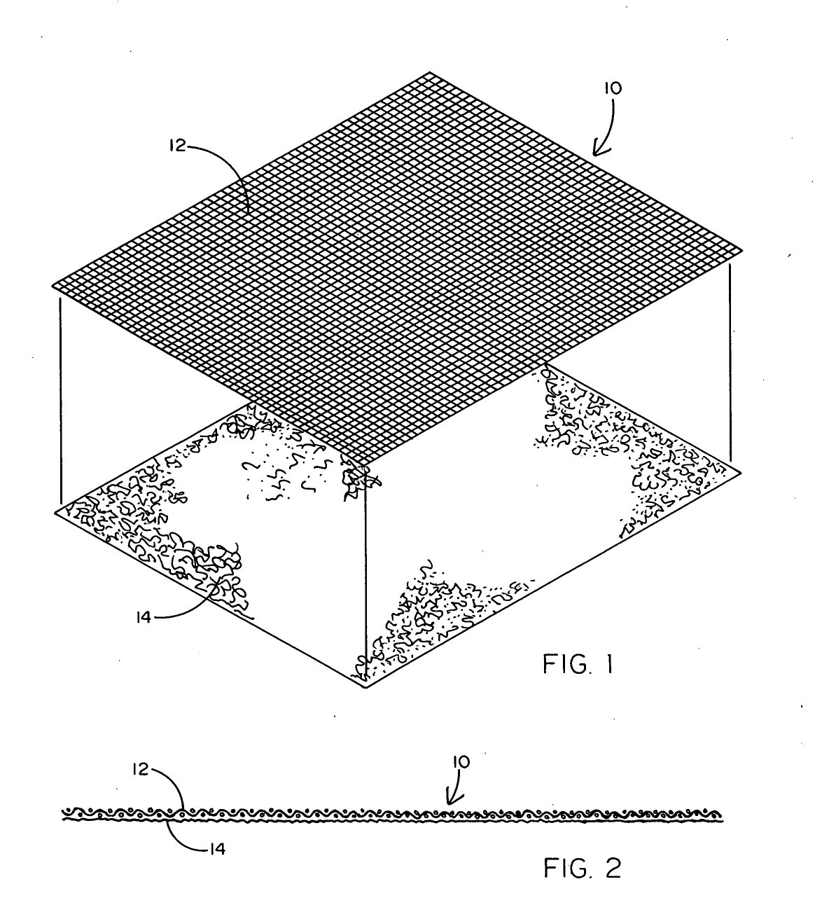

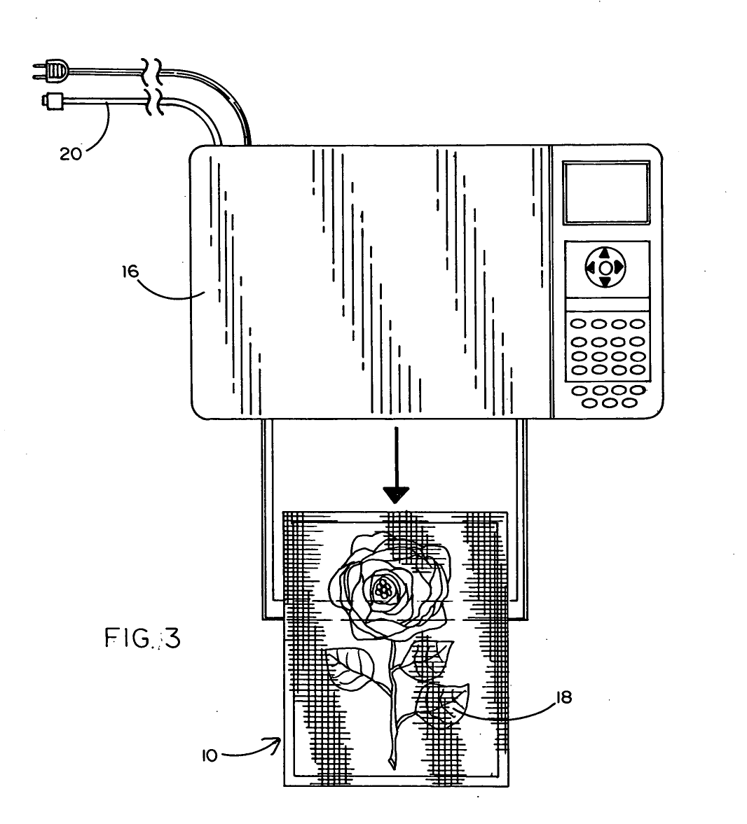

Referring to the accompanying figures; it will be seen in FIGS. 1 and 2 that a needlepoint laminated canvas 10 of a preferred embodiment of the present invention comprises a mesh 12 and a fusible interface backing 14. Mesh 12 is well known in the needlepoint craft field. It is the canvas surface upon which a needlepoint work is processed by stitching a yarn through generally square holes using needles through which the yarn is threaded. A mesh may come in various sizes based upon the fineness of the square holes per square inch. By way of example, a typical artistic needlepoint of about ½ to 1 square foot will use an 18 mesh canvas to achieve a fairly complex image. Larger works such as pillows and area rugs might use a 10 or 12 mesh canvas.

The fusible interface backing 14 is used in the preferred embodiment of the present invention to 1) stiffen the canvas to make stitching easier and more portable without the need for stretching the canvas; and 2) to result in a laminated canvas where the needlepoint design is more readily visible because ink from the design that does not appear on the upper surface of the mesh will appear on the backing surface in contact with the lower surface of the mesh. One such fusible interface backing that is suitable for use in the present invention is manufactured by Pellon of Tucker, Georgia and is applied using heat such as from a steam iron to form the laminate.

Once the laminated canvas 10 is completed, a suitable pattern or design 18 is applied to the canvas. This may be accomplished using a relatively standard computer-connected color printer such as printer 16 shown in FIG. 3. Printer 16 may be connected to a standard PC-type computer (not shown) using for example a USB cable 20. Printer 16 is preferably capable of handling relatively thick paper stock and may therefore be preferably of the flat-bed type which need not severely bend the print document. One such printer is by way of example, a Canon PIXMA PRO9000 II ink jet printer.

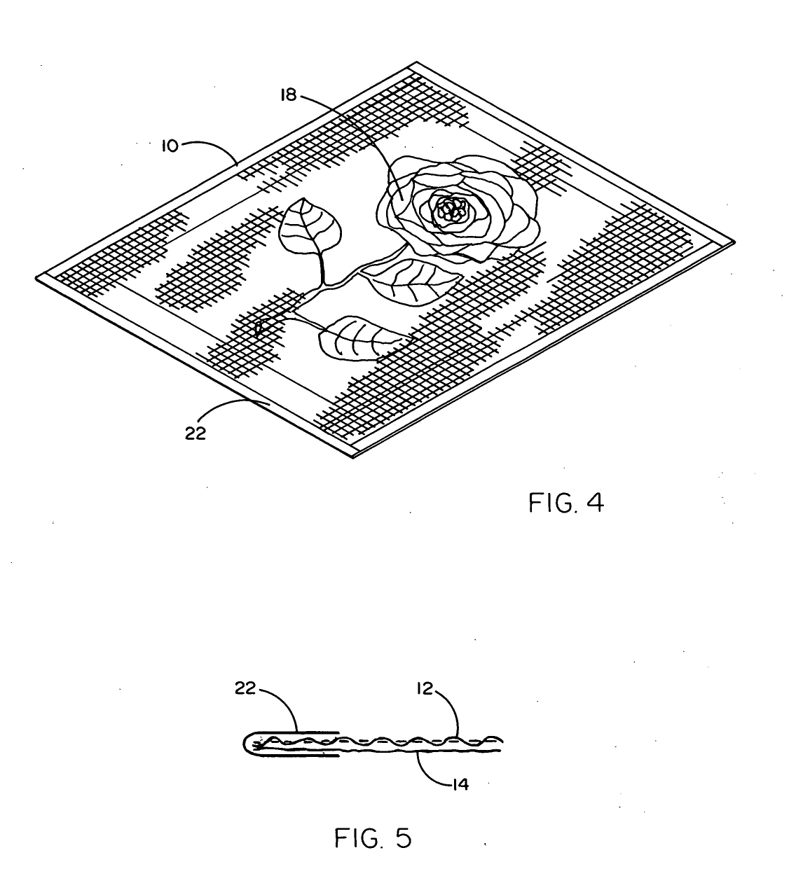

As shown in FIGS. 4 and 5, after the canvas laminate 10 is created by joining the mesh 12 and the fusible interface backing 14, and either before or after the printing of the design 18, a border tape 22 may be preferably applied to the perimeter edge of the laminate. The tape 22 serves two purposes. It further stiffens the laminate and it covers the edge which prevents it from fraying. To the extent that the laminate edge may already be frayed and roughened before the tape is applied, because it is preferably applied to cover the entire edge, the tape makes the edge smooth along the entire perimeter of the canvas laminate 10. Another alternative is to apply glue over the edges of the mesh and interface composite either by rolling, brushing spraying or dipping along the perimeter edge at the time the two layers are joined. The glue both provides additional stabilization for the mesh composite and smooths the edges.

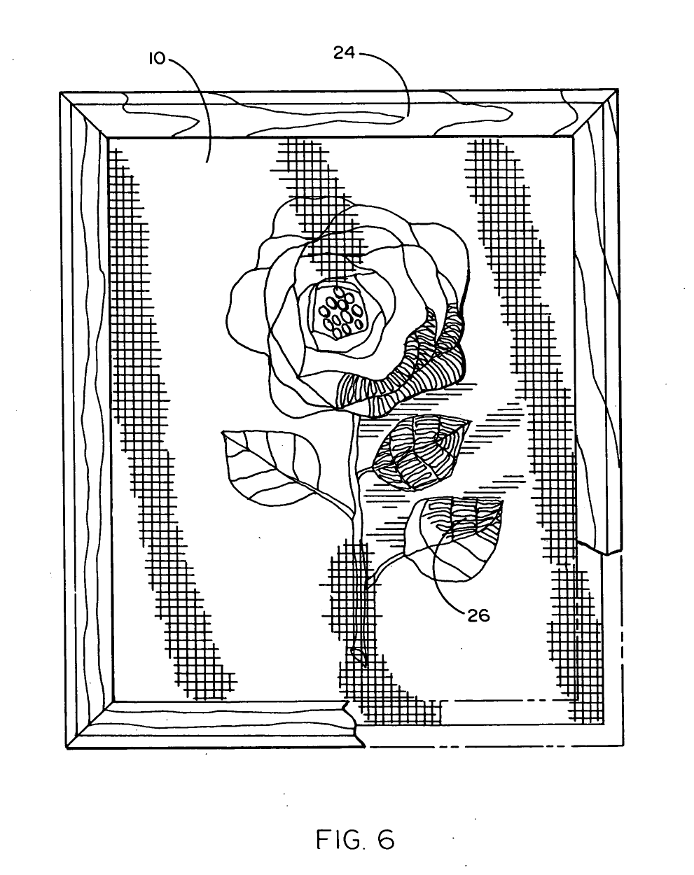

FIG. 6 illustrates a framed version of the invention wherein the printed laminate is either the size of or can be trimmed to the size of standard photograph frames 24. This feature permits a completed needlepoint (one with all of the stitching 26 in place) to be simply placed in a standard frame for display while obviating special costly post-stitching processing which is often needed to complete a conventional needlepoint project.

It will now be understood that the present invention comprises various improvements to the needlepoint art craft. These improvements include use of a mesh and fusible backing laminate canvas, printing onto both layers of the laminate to provide a more visible design pattern, taping and/or gluing the edge perimeter of the laminate to avoid rough frayed edges, and using canvas sizes that are compatible with standard photograph frame sizes to provide low cost display of the finished needlepoint.

It should also be understood that the present invention is not limited to the needlepoint craft. The principal features hereof are applicable to artistic endeavors involving a mesh or screen to which a design is applied. The process described herein may be used to create decorative window screens where a fusible interface is attached to a window screen material, a design is printed (no stitching) and then sealed. This allows for an unsightly view to be masked while preserving the air flow. Another application is fusing an interface layer to fabric netting in select locations and printing a design giving both the open mesh and design printed mesh that may or may not be stitched.

These and other inventive aspects of the preferred embodiments herein are recited in the appended claims and the scope of the invention is defined by such claims.

I claim:

1. A needlepoint canvas comprising:
a mesh for receiving needlepoint stitching according to a design pattern imprinted on a first surface of the mesh;
a fusible interface material affixed to a second surface of said mesh to form a multi-layer laminate therewith;
a design pattern imprinted on said first surface of said mesh and extending through apertures in said mesh to also be imprinted on said fusible interface material, said design pattern providing a visible indication of where different colors of yarn are to be stitched into said laminate.

2. The needlepoint canvas recited in claim 1 further comprising adhesive tape extending over said laminate along perimeter edges thereof.

3. The needlepoint canvas recited in claim 1 wherein said mesh and said fusible interface material are glued together by an applied bead of adhesive along contiguous perimeter edge surfaces.

4. The needlepoint canvas recited in claim 1 wherein said laminate is shaped to be received in available photograph frames.

5. A method of fabricating a needlepoint canvas; the method comprising the steps of:
a) providing a needlepoint mesh;
b) providing a fusible interface backing congruent to said mesh;
c) adhering said meshing and said backing together to form a laminate; and
d) printing a design pattern onto said laminate to form said pattern on the mesh and extending through the mesh and onto said backing.

6. The method recited in claim 5 further comprising the step of applying an adhesive tape along the perimeter edge of said laminate.

7. The method recited in claim 5 further comprising the step of applying a bead of adhesive between said mesh and said backing along a perimeter edge thereof.

8. The method recited in claim 5 wherein step c) is carried out by melting said fusible interface backing onto said mesh.

9. The method recited in claim 8 wherein said melting is carried out by applying a hot steam iron to said fusible interface backing while said backing is in contact with said mesh.

10. The method recited in claim 5 further comprising the step of shaping said mesh to conform to existing photograph frames for displaying a finished needlepoint canvas therein.

11. A flexible mesh composite material, comprising:
a mesh for receiving augmentation according to a design or pattern, the mesh being composed of non-elastic perpendicular members forming a uniform grid with mesh apertures, the apertures being of a size greater than the perpendicular members;
a fusible interface material affixed to the surface of said mesh to form a multi-layer laminate therewith; and
a design applied to said mesh and extending through the apertures in said mesh to also be applied simultaneously onto said fusible interface material, said design providing a visible indication of where different aspects and colors of the design are to be worked onto said composite.

12. The flexible mesh composite material recited in claim 11 stabilized by applying an adhesive or other fixing agent around the contiguous perimeter edge surface of the mesh composite.

13. The flexible mesh composite material recited in claim 11 stabilized by applying an adhesive or other fixing agent across the entire mesh composite.

14. The edges of the flexible mesh composite recited in claim 11 protected by an adhesive tape extending over said composite along the perimeter edge thereof.

15. The flexible mesh composite recited in claim 11 shaped in dimensions corresponding to typical frame sizes.

16. A method of fabricating flexible mesh composite; the method comprising the steps of:
a. providing a mesh;
b. providing a fusible interface material layer congruent to said mesh;
c. adhering said mesh and said interface layer together to form a composite; and
d. applying a design onto the mesh and extending through the mesh onto said interface layer.

17. The method recited in claim 16 further comprising the step of applying adhesive or other fixing agent around the perimeter edges of the composite.

18. The method recited in claim 16 further comprising the step of applying adhesive or other fixing agent across the entire composite.

19. The method recited in claim 16 further comprising the step of applying an adhesive tape along the perimeter edge of said composite.

20. The method recited in claim 16 wherein step c) is carried out by melting said fusible interface layer onto said mesh.

21. The method recited in claim 20 wherein said melting is accomplished by applying steam heat to said fusible interface layer while said layer is in contact with said mesh.

22. The method recited in claim 16 further comprises the step of shaping said mesh composite to conform to the dimensions of existing frames for displaying the design therein.
